(19) United States
(12) Patent Application Publication
(10) Pub. No.: US 2024/0416964 A1
(43) Pub. Date: Dec. 19, 2024

(54) AUTONOMOUS DRIVING MODE CONTROL METHOD AND APPARATUS BASED ON SITUATION

(71) Applicants: Hyundai Motor Company, Seoul (KR); Kia Corporation, Seoul (KR)

(72) Inventors: Eun Young CHOI, Seoul (KR); Dong Kyu KIM, Hwaseong-si (KR); Sun Seong HONG, Yeongtong-gu (KR); Dae Woon KIM, Suwon-si (KR)

(73) Assignees: Hyundai Motor Company, Seoul (KR); Kia Corporation, Seoul (KR)

(21) Appl. No.: 18/388,998

(22) Filed: Nov. 13, 2023

(30) Foreign Application Priority Data
Jun. 19, 2023 (KR) 10-2023-0078087

(51) Int. Cl. B60W 60/00; B60L 58/13; B60W 30/182; B60W 40/02; B60W 40/08; B60W 50/08; B60W 50/14

(52) U.S. Cl. CPC B60W 60/0018; B60L 58/13; B60W 30/182; B60W 40/02; B60W 40/08; B60W 50/082; B60W 50/14; B60L 2240/60; B60L 2260/50; B60W 2040/0827; B60W 2510/244; B60W 2540/223; B60W 2540/229; B60W 2552/30; B60W 2555/20; B60W 2556/50

(57) ABSTRACT

An autonomous driving mode control method includes setting a driving route based on an origin and a destination of a vehicle, comparing an expected state of charge (SOC) value of a battery at the destination with a predetermined SOC value, and controlling travel of the vehicle by determining whether to activate a high-level driving mode in consideration of at least one of whether a dangerous situation occurs, a result of the comparing, or a safety level of the driving route.

### CROSS REFERENCE TO RELATED APPLICATION

The present application claims priority to Korean Patent Application No. 10-2023-0078087 filed on Jun. 19, 2023, the entire contents of which is incorporated herein for all purposes by this reference.

### BACKGROUND OF THE PRESENT DISCLOSURE

### Field of the Present Disclosure

The present disclosure relates to autonomous driving, and more specifically, to a technology for analyzing a situation of an autonomous driving vehicle and providing a driver with an autonomous driving mode of the vehicle according to a result of the analysis.

### Description of Related Art

An autonomous driving level of an autonomous driving vehicle is classified according to a level at which a system performs driving of the vehicle. The classification is that Level 0 is non-automation, Level 1 is driver assistance, Level 2 is partial automation, Level 3 is conditional automation, Level 4 is high-degree automation, and Level 5 is full automation.

In Levels 0 to 2, a driver takes responsibility for driving, and in Levels 3 to 5, an autonomous driving system takes responsibility for driving. Level 1 means that a vehicle is in charge of acceleration and deceleration operations, and the driver is in charge of steering. The vehicle is equipped with driver assistance systems such as lane origin warning and emergency braking. In Level 2, the vehicle is in charge of acceleration and deceleration operations and steering, and the driver should continuously monitor a situation around the vehicle. In Level 3, a driving subject is changed from a human to a computer. In Level 3, the vehicle itself may directly perform steering, acceleration and deceleration, and braking, and control authority is frequently switched between the driver and an autonomous driving system (advanced driver assist system (ADAS)) in a limited section. Level 4 is autonomous driving which is available only in a specific environment, and the vehicle travels without human intervention. In Level 5, the vehicle may autonomously travel anytime, anywhere without human intervention.

Meanwhile, an autonomous driving vehicle of Level 4 or higher may complexly include Level 3, Level 2, and Level 1 in a driving route according to a manufacturer's designated driving region. Upon traveling after setting a long-distance destination route, in electric vehicles, battery management, that is, the management of a distance to empty is essential, and the number of sensors and information throughput used in the vehicle vary depending on the autonomous driving level, which is directly related to a battery usage.

In Levels 2 and 3 of the autonomous driving, the vehicle serves to partially assist the driver in a travel situation, and there is no significant difference in power consumption, but in Level 4, because the information throughput rapidly increases and thus may increase power consumption, there is a possibility that the driving distance of the vehicle may be reduced.

Therefore, in the present art, there is a demand for a technology capable of minimizing power consumption of the vehicle by optimizing the autonomous driving level for each road section in the driving route of the autonomous driving vehicle and recommending the optimized level to the driver.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a technology configured for minimizing power consumption of a vehicle by optimizing an autonomous driving level for each road section in a driving route of an autonomous driving vehicle and recommending the optimized level to a driver.
an autonomous driving mode control method according to an exemplary embodiment of the present disclosure includes setting a driving route based on an origin and a destination of a vehicle, comparing an expected state of charge (SOC) value of a battery at the destination with a predetermined SOC value, and controlling travel of the vehicle by determining whether to activate a high-level driving mode in consideration of at least one of whether a dangerous situation occurs, a result of the comparing, or a safety level of the driving route.

In the instant case, the controlling of the travel of the vehicle may further include warning the dangerous situation to a driver when the dangerous situation occurs while the vehicle travels and transmitting an inquiry about whether to activate the high-level driving mode to the driver, and controlling the travel of the vehicle by activating the high-level driving mode upon receiving acceptance of the activation for the high-level driving mode from the driver.

In the instant case, the autonomous driving mode control method may further include controlling the travel of the vehicle by activating the high-level driving mode when the expected SOC value of the battery at the destination is equal to or greater than the predetermined SOC value, and controlling the travel of the vehicle by downgrading an autonomous driving level when the safety level of the driving route is greater than a predetermined safety level.

In the instant case, the safety level of the driving route may be determined based on a number of vehicles passing a forward road in the driving route, a curvature of the forward road in the driving route, and a visibility range.

In the instant case, the autonomous driving mode control method may further include adding a charging station in the driving route as a stopover.

In the instant case, the dangerous situation may include a dangerous state of the driver or a bad weather state.

In the instant case, the dangerous state of the driver may include any one of a drowsy driving state of the driver and a distracted state of the driver.

In the instant case, the drowsy driving state of the driver may be a state in which the driver's eyelids are closed beyond a predetermined range.

In the instant case, the distracted state of the driver may be a state in which the driver's head rotates at a predetermined angle or more than the predetermined angle from a front of the driver.

Furthermore, the bad weather state may include any one of a state in which an external temperature is out of a predetermined temperature or higher than the predetermined temperature, a state of being forecasted that precipitation which is greater than or equal to predetermined precipitation has occurred or will occur, a state in which a wind speed is higher than or equal to a predetermined speed, or a combination thereof.

Furthermore, an autonomous driving mode control apparatus according to an exemplary embodiment of the present disclosure includes a sensor unit configured to obtain a battery state of a vehicle, driving situation information of the vehicle, or state information of a driver, a communication unit configured to receive situation information of the vehicle, an origin or a destination of the vehicle, or external environment information of the vehicle from an external server or an external device, and a controller configured to control travel of the vehicle by setting a driving route based on the origin and the destination, comparing an expected state of charge (SOC) value of a battery at the destination with a predetermined SOC value, and determining whether to activate a high-level driving mode in consideration of at least one of whether a dangerous situation occurs, a result of the comparing, or a safety level of the driving route.

In the instant case, the controller may warn the dangerous situation to a driver when the dangerous situation occurs while the vehicle travels and transmit an inquiry about whether to activate the high-level driving mode to the driver, and control the travel of the vehicle by activating the high-level driving mode upon receiving acceptance of the activation for the high-level driving mode from the driver.

In the instant case, the controller may be configured for controlling the travel of the vehicle by activating the high-level driving mode when the expected SOC value of the battery at the destination is equal to or greater than the predetermined SOC value, and control the travel of the vehicle by downgrading an autonomous driving level when the safety level of the driving route is greater than a predetermined safety level.

In the instant case, the safety level of the driving route may be determined based on a number of vehicles passing a forward road in the driving route, a curvature of the forward road in the driving route, and a visibility range.

In the instant case, the controller may add a charging station in the driving route as a stopover.

In the instant case, the dangerous state may include a dangerous state of a driver or a bad weather state.

In the instant case, the dangerous state of the driver may include any one of a drowsy driving state of the driver and a distracted state of the driver.

In the instant case, the drowsy driving state of the driver may be a state in which the driver's eyelids are closed beyond a predetermined range.

In the instant case, the distracted state of the driver may be a state in which the driver's head rotates at a predetermined angle or more than the predetermined angle from a front of the driver.

In addition, the bad weather state may include any one of a state in which an external temperature is out of a predetermined temperature or higher than the predetermined temperature, a state of being forecasted that precipitation that is greater than or equal to predetermined precipitation has occurred or will occur, a state in which a wind speed is higher than or equal to a predetermined speed, or a combination thereof.

As described above, according to various embodiments of the present disclosure, it is possible to minimize power consumption of the vehicle by optimizing the autonomous driving level for each road section in the driving route of the autonomous driving vehicle and recommending the optimized level to the driver.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating a change in power consumption of a vehicle upon traveling at different autonomous driving levels for each road section in a driving route of an autonomous driving vehicle;

FIG. 2 is a block diagram illustrating a configuration of an autonomous driving mode control apparatus according to an exemplary embodiment of the present disclosure;

FIG. 3A and FIG. 3B are flowcharts illustrating an autonomous driving mode control method according to an exemplary embodiment of the present disclosure; and

FIG. 4 is a block diagram illustrating a computer system according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments included in the present specification will be described in detail with reference to the accompanying drawings, and the same or similar components are denoted by the same reference numerals regardless of the drawing symbols, and overlapping descriptions thereof will be omitted. The suffixes “module” and “unit” for components used in the following description are provided or used interchangeably in consideration of ease of writing the specification and do not have meanings or roles that are distinct from each other by themselves. Furthermore, in describing the exemplary embodiments included in the present specification, when it is determined that a detailed description of a related known technology may obscure the gist of the exemplary embodiments included in the present specification, a detailed description thereof will be omitted. Furthermore, the accompanying drawings are only for easy understanding of the exemplary embodiments included in the present specification, and it should be understood that the technical spirit included in the present specification is not limited by the accompanying drawings, and all changes, equivalents, or substitutes included in the spirit and technical scope of the present disclosure are included in the accompanying drawings.

Terms including ordinal numbers such as second or first may be used to describe various components, but the components are not limited by the terms. The terms are used only for distinguishing one component from another.

When a certain component is referred to as being “connected” or “coupled” to another component, it is understood that it may be directly connected or coupled to another component or other components may also be disposed therebetween. On the other hand, when a certain component is referred to as being “directly connected” or “directly coupled” to another component, it should be understood that other components are not present therebetween.

The singular expression includes the plural expression unless the context clearly dictates otherwise.

In the specification, it should be understood that terms such as “comprise” or “have” are intended to specify that a feature, a number, a step, an operation, a component, a portion, or a combination thereof described in the specification is present, but do not preclude the possibility of the presence or addition of one or more other features, numbers, steps, operations, components, parts, or combinations thereof.

When a destination is set from an origin, an autonomous driving vehicle may travel along a driving route from the origin to a destination in various driving modes ranging from Level 1 to Level 4 of autonomous driving for each section.

Upon traveling after setting a long-distance destination route, in electric vehicles, battery management, that is, the management of a distance to empty is essential, and the number of sensors and information throughput used in the vehicle vary depending on the autonomous driving level, which is directly related to a battery usage.

For example, an autonomous driving vehicle may require the number of sensors and data processing scale as expressed in Table 1 below according to the autonomous driving level.

TABLE 1

| | Level 2 | Level 3 | Level 4 | Level 5 |
|---|---|---|---|---|
| The number of required sensors | 17 | 29 | 30 | 32 |
| Required data processing scale | 1~5 | 5~30 | 50 | 100 |
| (Tera operations per second | | | | |
| (TON)) | | | | |

Referring to Table 1, it may be seen that the number of required sensors and the required data processing scale of the autonomous driving vehicle increase as the autonomous driving level increases. Therefore, as the autonomous driving level increases, power consumption of the vehicle may also increase.

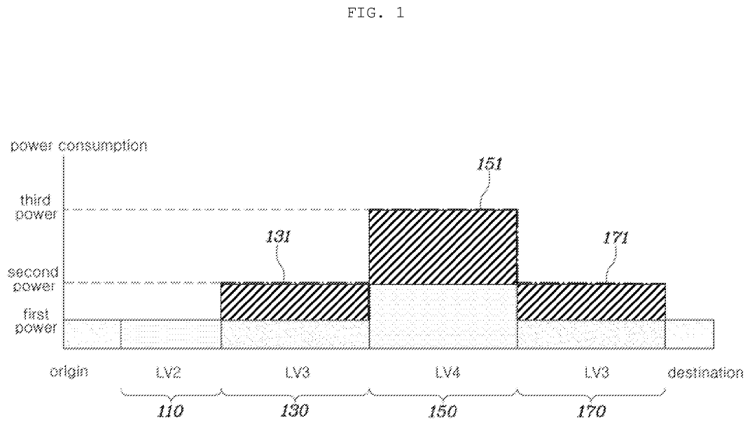

FIG. 1 is a view exemplarily illustrating a change in power consumption of a vehicle upon traveling at different autonomous driving levels for each road section in a driving route of an autonomous driving vehicle.

Referring to FIG. 1, the autonomous driving vehicle may travel a route from an origin to a destination in a Level 2 mode in a first section 110, in a Level 3 mode in a second section 130, in a Level 4 mode in a third section 150, and in a Level 3 mode in a fourth section 170.

In the instant case, assuming that all of conditions of distances, slopes of road surfaces, and the like of the first to fourth sections 110, 130, 150, and 170 are the same, first power may be consumed in the first section 110, second power may be consumed in the second section 130 and the fourth section 170, and third power may be consumed in the third section 150.

However, in a situation in which the remaining state of charge of a vehicle battery is insufficient to complete the travel from the origin to the destination, it is possible to reduce battery consumption by downgrading the autonomous driving level. For example, when the vehicle travels in the Level 2 mode instead of the Level 3 mode in the second section 130, battery consumption is reduced as much as power 131, when the vehicle travels in the Level 3 mode instead of the Level 4 mode in the third section 150, battery consumption is reduced as much as power 151, and when the vehicle travels in the Level 2 mode instead of the Level 3 mode in the fourth section 170, battery consumption is reduced as much as power 171.

Therefore, if the autonomous driving level is downgraded under a predetermined condition in which the remaining state of charge of the battery is insufficient, it is possible to secure a distance to empty by minimizing power consumption.

Hereinafter, an apparatus and method configured for minimizing power consumption of a vehicle by optimizing an autonomous driving level for each road section in a driving route of the autonomous driving vehicle and recommending the optimized level to a driver, will be explained.

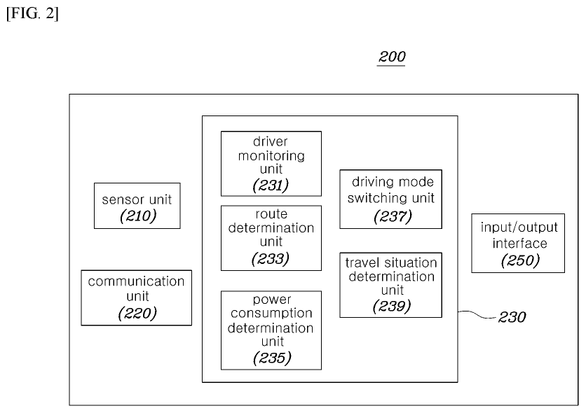

FIG. 2 is a block diagram illustrating a configuration of an apparatus for controlling an autonomous driving mode according to an exemplary embodiment of the present disclosure.

Referring to FIG. 2, an autonomous driving mode control apparatus 200 according to the exemplary embodiment of the present disclosure includes a sensor unit 210, a controller 230, and an input/output interface 250.

The sensor unit 210 obtains a battery state of a vehicle, travel situation information of the vehicle, or state information of a driver to provide the autonomous driving mode of the vehicle. The sensor unit 210 may include a light detection and ranging (LiDAR) sensor, a Global Positioning System (GPS) sensor, a microphone, a camera, etc.

For example, the LiDAR sensor recognizes nearby vehicles, obstacles, pedestrians, or the like by measuring a time returned after emitting a laser beam around the vehicle.

Furthermore, the Global Positioning System (GPS) sensor receives information on a current position of the vehicle from GPS satellites.

Furthermore, the microphone measures a sound inside or outside the vehicle. For example, the microphone may be used to obtain information on the driver by recognizing the vehicle driver's voice.

Furthermore, the camera captures an inside or outside of the vehicle. For example, the camera may be used to obtain information on the driver by capturing the vehicle driver.

The communication unit 220 receives situation information of the vehicle, origin or destination information, or external environment information of the vehicle from an external server or external device and transmits the received information to the controller 230. The communication unit 220 may receive, for example, information on a map from a map server and transmit the received information to the controller 230. Furthermore, the communication unit 220 may receive weather information such as temperature, precipitation, and wind from a weather server and transmit the received weather information to the controller 230.

Furthermore, the communication unit 220 may receive information on the origin and destination of the vehicle from a user terminal (UE) or the like.

The controller 230 is configured to determine an autonomous driving mode based on the information obtained from the sensor unit 210 or the communication unit 220 to control the vehicle or provide the autonomous driving mode to the driver through the input/output interface 250.

The controller 230 includes a driver monitoring unit 231, a route determination unit 233, a power consumption determination unit 235, a driving mode switching unit 237, and a travel situation determination unit 239.

The driver monitoring unit 231 is configured to determine a driver's state based on detecting information received from the sensor unit 210.

In the instant case, the driver's state may include a drowsy driving state or a distracted state.

For example, when the driver's eyelids are closed above a predetermined range, the driver monitoring unit 231 may be configured to determine that the driver's state is the drowsy driving state.

Furthermore, the driver monitoring unit 231 may be configured to determine that the driver's state is the distracted state when the driver's head rotates at a predetermined angle or more than the predetermined angle from the front.

Meanwhile, the route determination unit 233 is configured to determine the driving route of the vehicle based on the information on the origin and destination of the vehicle.

In the instant case, the information on the origin of the vehicle may be received from the sensor unit 210.

For example, the information on the origin of the vehicle may be received from the GPS sensor included in the sensor unit 210.

Furthermore, the information on the destination of the vehicle may be received by the communication unit 220 or the input/output interface 250.

For example, the information on the destination of the vehicle may be received from user equipment of the driver or a touch screen included in the input/output interface 250.

The power consumption determination unit 235 is configured to determine the autonomous driving mode for each road section based on the driving route of the vehicle determined by the route determination unit 233 and is configured to determine the power consumption required to travel from the origin to the destination based on the autonomous driving mode for each road section.

For example, the power consumption determination unit 235 may be configured to determine the autonomous driving mode so that the vehicle travels in the Level 1 mode when the road section is a city travel road, travels in the Level 2 mode when the road section is an expressway, travels in the Level 3 mode in some highways sections, and travels in the Level 4 mode in other highway sections excluding some highways in which the vehicle travels in the Level 3 mode.

Furthermore, the power consumption determination unit 235 may derive fuel efficiency by predicting an average speed for each road section and determine a demand power required for traveling from the origin to the destination based on the derived fuel efficiency.

Furthermore, the power consumption determination unit 235 is configured to determine an expected state of charge (SOC) at the destination based on a current SOC value of the vehicle battery and the power consumption required for traveling from the origin to the destination.

Furthermore, the driving mode switching unit 237 sets the autonomous driving level in each road section determined by the power consumption determination unit 235 again based on the state information of the autonomous driving vehicle and the driver.

For example, when the expected SOC value at the destination is smaller than a predetermined SOC value, the driving mode switching unit 237 may travel after deactivating a high-level driving mode of the vehicle.

For example, the predetermined SOC may be 30%.

In the instant case, the high-level driving mode may include a driving mode of the autonomous driving Level 3 or Level 4.

Therefore, when the high-level driving mode is deactivated, the autonomous driving mode control apparatus 200 may be configured for controlling travel of the vehicle by setting the autonomous driving mode to Level 1 or Level 2.

Furthermore, in the event of a dangerous situation, the driving mode switching unit 237 may allow the vehicle to travel by warning the driver that the dangerous situation has occurred, transmitting an inquiry about whether to activate the high-level driving mode, and activating the high-level driving mode of the vehicle based on a response to this.

In the instant case, the warning may be transmitted to the driver through a warning sound or a pop-up on a display screen through the user interface 250.

In the instant case, the dangerous situation may include a dangerous state of the driver or a bad weather state.

In the instant case, the dangerous state of the driver may include any one of the drowsy driving state of the driver and the distracted state of the driver.

In the instant case, when the driver's eyelids are closed above a predetermined range, it may be determined that the driver's state is the drowsy driving state.

In the instant case, when the driver's head rotates at a predetermined angle or more from the front, it may be determined that the driver's state is the distracted state.

Furthermore, the bad weather state may include any one of a state in which an external temperature is out of a predetermined temperature, a state of being forecasted that precipitation that is greater than or equal to predetermined precipitation has occurred or will occur, a state in which a wind speed is higher than or equal to a predetermined speed, or a combination thereof.

Furthermore, the driving mode switching unit 237 may allow the vehicle to travel by determining a safety level of the driving route from the current position to the destination in real time, transmitting an inquiry about whether to downgrade the autonomous driving level to the driver when the safety level of the driving route is greater than a predetermined safety level, downgrading the autonomous driving level based on a response to the inquiry, and switching the control authority of the vehicle.

In the instant case, the safety level of the driving route may be determined based on a number of vehicles passing a forward road in the driving route, a curvature of the forward road in the driving route, and a visibility range.

In the instant case, as the number of vehicles passing the forward road in the driving route decreases, the safety level of the driving route may increase.

In the instant case, as the curvature of the forward road in the driving route decreases, the safety level of the driving route may increase.

In the instant case, as the visibility range increases, the safety level of the driving route may increase.

In the instant case, when the vehicle or the autonomous driving control apparatus includes the control authority of the vehicle, the travel of the vehicle may be controlled by switching the control authority of the vehicle to the driver.

In the instant case, when a dangerous situation occurs while the vehicle travels after downgrading the autonomous driving level and switching the control authority, the driving mode switching unit 237 may allow the vehicle to travel with the autonomous driving level before the autonomous driving level is downgraded and the control authority before switched to the driver.

The travel situation determination unit 239 is configured to determine the safety level of the driving route based on a traffic volume in the route from the origin to the destination, a regenerative braking usage rate according to a road slope, and weather information.

In the instant case, the information on the traffic volume in the route from the origin to the destination may be received from a traffic information server by the communication unit 220.

In the instant case, the information on the road slope may be received from a map server by the communication unit 220.

In the instant case, the weather information may be received from a weather server by the communication unit 220.

Furthermore, the travel situation determination unit 239 is configured to determine whether a dangerous situation has occurred based on the state information of the driver or the weather information determined by the driver monitoring unit 231 and transmits a result of the determination to the driving mode switching unit 237.

The input/output interface 250 provides the driver of the vehicle with recommendation information on the autonomous driving mode according to a situation of the vehicle or receives whether to accept the recommendation information on the autonomous driving mode from the driver.

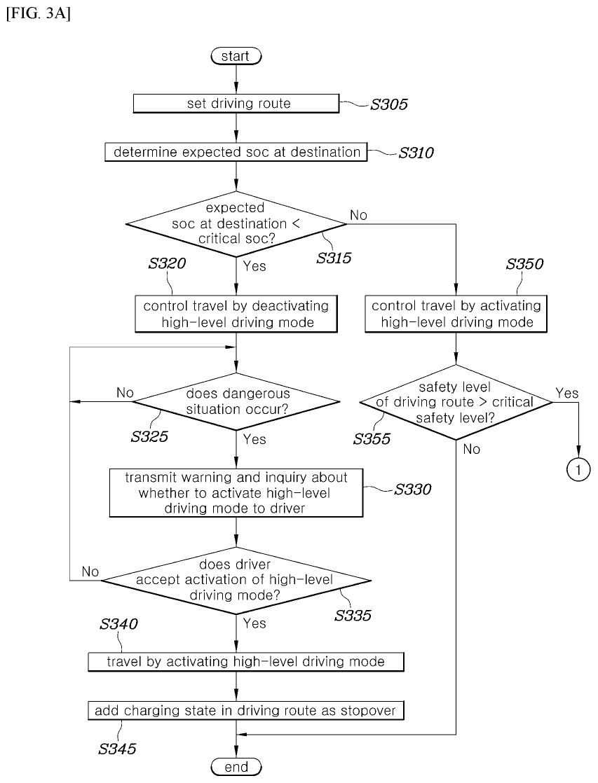

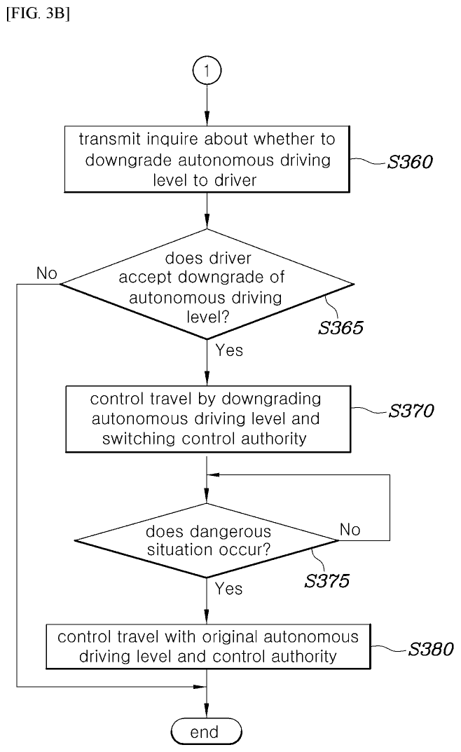

FIG. 3A and FIG. 3B are flowcharts illustrating an autonomous driving mode control method according to an exemplary embodiment of the present disclosure.

The autonomous driving mode control method according to the exemplary embodiment of the present disclosure may be performed by the autonomous driving mode control apparatus 200 according to the exemplary embodiment of FIG. 2.

Referring to FIG. 3A and FIG. 3B, the autonomous driving mode control apparatus 200 sets the driving route of the vehicle based on the origin and destination of the vehicle (S305).

In the instant case, the origin of the vehicle may be a current position of the vehicle.

In the instant case, the current position of the vehicle may be received from the GPS sensor.

For example, the information on the origin of the vehicle may be received from the GPS sensor included in the sensor unit 210.

For example, the information on the destination of the vehicle may be received from user equipment of the driver or a touch screen included in the input/output interface 250.

Furthermore, the autonomous driving mode control apparatus 200 is configured to determine the expected SOC at the destination of the vehicle (S310).

In the instant case, the autonomous driving mode control apparatus 200 may be configured to determine the power consumption required for traveling from the origin to the destination based on the autonomous driving mode for each road section.

For example, the autonomous driving mode control apparatus 200 may be configured to determine the autonomous driving mode so that the vehicle travels in the Level 1 mode when the road section is a city travel road, travels in the Level 2 mode when the road section is an expressway, travels in the Level 3 mode in some highways sections, and travels in the Level 4 mode in the other highway sections excluding some highways in which the vehicle travels in the Level 3 mode.

Furthermore, the autonomous driving mode control apparatus 200 may derive fuel efficiency by predicting an average speed for each road section and determine demand power required for traveling from the origin to the destination based on the derived fuel efficiency.

Furthermore, the autonomous driving mode control apparatus 200 determines an expected SOC value at the destination based on a current SOC value of the vehicle battery and the power consumption required for traveling from the origin to the destination.

Furthermore, the autonomous driving mode control apparatus 200 determines whether the expected SOC at the destination is smaller than the predetermined SOC (S315) and is configured to control the travel of the vehicle by deactivating the high-level driving mode of the vehicle when the expected SOC at the destination is smaller than the predetermined SOC (S320).

For example, the predetermined SOC may be 30%.

In the instant case, the high-level driving mode may include a driving mode of the autonomous driving Level 3 or Level 4.

Therefore, when the high-level driving mode is deactivated, the autonomous driving mode control apparatus 200 may be configured for controlling travel of the vehicle by setting the autonomous driving mode to Level 1 or Level 2.

Furthermore, the autonomous driving mode control apparatus 200 is configured to determine whether the dangerous situation of the vehicle has occurred (S325).

As a result of the determination in operation S325, in the event of the dangerous situation, the autonomous driving mode control apparatus 200 warns the driver that the dangerous situation has occurred and transmits the inquiry about whether to activate the high-level driving mode to the driver (S330).

In the instant case, the warning may be transmitted to the driver through a warning sound or a pop-up on a display screen through the user interface 250.

In the instant case, the dangerous situation may include a dangerous state of the driver or a bad weather state.

In the instant case, the dangerous state of the driver may include any one of the drowsy driving state of the driver and the distracted state of the driver.

In the instant case, when the driver's eyelids are closed above a predetermined range, it may be determined that the driver's state is the drowsy driving state.

In the instant case, when the driver's head rotates at a predetermined angle or more from the front, it may be determined that the driver's state is the distracted state.

Furthermore, the bad weather state may include any one of a state in which an external temperature is out of a predetermined temperature, a state of being forecasted that precipitation which is greater than or equal to predetermined precipitation has occurred or will occur, a state in which a wind speed is higher than or equal to a predetermined speed, or a combination thereof.

Furthermore, the autonomous driving mode control apparatus 200 is configured to determine whether the driver has accepted the activation of the high-level driving mode (S335).

In the instant case, the autonomous driving mode control apparatus 200 may display a button to select “Accept” or “Reject” on a display screen of a driver's seat and receive a touch on the screen to determine that the driver has accepted the activation of the high-level driving mode when the “Accept” button is touched.

As a result of the determination in operation S335, when the driver accepts the activation of the high-level driving mode, the autonomous driving mode control apparatus 200 is configured to control the travel of the vehicle by activating the high-level driving mode (S340).

In the instant case, when the high-level driving mode is activated, the autonomous driving mode control apparatus 200 may be configured for controlling the travel of the vehicle by setting the autonomous driving mode to Level 3 or Level 4.

In the instant case, the autonomous driving mode control apparatus 200 may be configured for controlling the travel of the vehicle by returning to the autonomous driving mode before deactivating the autonomous driving mode.

Furthermore, the autonomous driving mode control apparatus 200 may add a charging station in the driving route as a stopover (S345).

In the instant case, the charging station may be an electric vehicle charging station, a hydrogen vehicle charging station, or a gas station.

In the instant case, the autonomous driving mode control apparatus 200 may change the driving route to pass the charging station.

In the instant case, when there is no charging station in the driving route, the autonomous driving mode control apparatus 200 may add a charging station positioned closest to the driving route as a stopover.

Meanwhile, as a result of the determination in operation S315, when the expected SOC at the destination is not smaller than the predetermined SOC value, the autonomous driving mode control apparatus 200 is configured to control the travel of the vehicle by activating the high-level driving mode of the vehicle (S350).

Furthermore, the autonomous driving mode control apparatus 200 is configured to determine whether the safety level of the driving route of the vehicle is greater than the predetermined safety level (S355).

In the instant case, the safety level of the driving route may be determined based on the number of vehicles passing a forward road in the driving route, a curvature of the forward road in the driving route, and a visibility range.

In the instant case, as the number of vehicles passing the forward road in the driving route decreases, the safety level of the driving route may increase.

In the instant case, as the curvature of the forward road in the driving route decreases, the safety level of the driving route may increase.

In the instant case, as the visibility range increases, the safety level of the driving route may increase.

As a result of the determination in operation S355, when the safety level of the driving route is greater than the predetermined safety level, the autonomous driving mode control apparatus 200 transmits an inquiry about whether to downgrade the autonomous driving level (S360) and is configured to determine whether the driver has accepted the downgrade of the autonomous driving level (S365).

In the instant case, the autonomous driving mode control apparatus 200 may display a button to select “Accept” or “Reject” on a display screen of a driver's seat and receive a touch on the screen to determine that the driver has accepted the activation of the high-level driving mode when the “Accept” button is touched.

As a result of the determination in operation S365, when the driver accepts the downgrade of the autonomous driving level, the autonomous driving mode control apparatus 200 downgrades the autonomous driving level and is configured to control the travel of the vehicle by switching the control authority of the vehicle (S370).

In the instant case, when the vehicle or the autonomous driving control apparatus includes the control authority of the vehicle, the travel of the vehicle may be controlled by switching the control authority of the vehicle to the driver.

Furthermore, the autonomous driving mode control apparatus 200 is configured to determine whether the dangerous situation of the vehicle has occurred (S375) and is configured to control the travel of the vehicle with the original autonomous driving level and with the control authority when the dangerous situation of the vehicle has occurred (S380).

In the instant case, the dangerous situation may include a dangerous state of the driver or a bad weather state.

In the instant case, the dangerous state of the driver may include any one of the drowsy driving state of the driver and the distracted state of the driver.

In the instant case, when the driver's eyelids are closed above a predetermined range, it may be determined that the driver's state is the drowsy driving state.

In the instant case, when the driver's head rotates at a predetermined angle or more from the front, it may be determined that the driver's state is the distracted state.

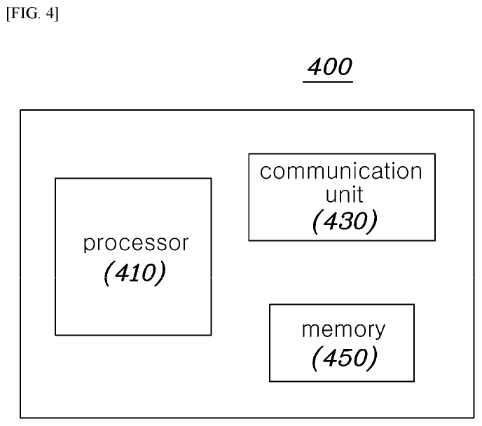

FIG. 4 is a block diagram illustrating a computer system according to an exemplary embodiment of the present disclosure.

Referring to FIG. 4, the exemplary embodiment of the present disclosure may be implemented in a computer system such as a computer-readable recording medium. As illustrated in FIG. 4, a computer system 400 includes a processor 410, a communication unit 430, and a memory 450, and the communication unit 430 communicates with an external server or an external device.

The processor 410 implements the autonomous driving mode control method and apparatus based on the situation provided herein. The processor 410 implements all operations of the autonomous driving mode control method and apparatus based on the situation described in the exemplary embodiment included herein, and all operations of an autonomous driving mode providing apparatus and method illustrated in FIGS. 2, 3A, and 3B.

For example, the processor 410 may be configured for controlling the travel of the vehicle by setting the driving route based on the origin and the destination and deactivating the high-level driving mode when the expected SOC value of the battery at the destination is smaller than the predetermined SOC value, and control the travel of the vehicle by warning the dangerous situation to the driver when the dangerous situation occurs while the vehicle travels and activating the high-level driving mode.

In the instant case, the high-level driving mode may be a mode in which the vehicle travels in the autonomous driving Level 3 or Level 4.

In the instant case, the processor 410 may be configured for controlling the travel of the vehicle by activating the high-level driving mode when the expected SOC value of the battery at the destination is not smaller than the predetermined SOC value, and control the travel of the vehicle by downgrading the autonomous driving level when the safety level of the driving route is greater than the predetermined safety level.

In the instant case, the safety level of the driving route may be determined based on the number of vehicles passing a forward road in the driving route, a curvature of the forward road in the driving route, and a visibility range.

In the instant case, the processor 410 may add a charging station in the driving route as a stopover.

In the instant case, the dangerous situation may include a dangerous state of the driver or a bad weather state.

In the instant case, the dangerous state of the driver may include any one of a drowsy driving state of the driver and a distracted state of the driver.

In the instant case, the drowsy driving state of the driver may be a state in which the driver's eyelids are closed above a predetermined range.

In the instant case, the distracted state of the driver may be a state in which the driver's head rotates at a predetermined angle or more than the predetermined angle from a front of the driver.

Furthermore, the bad weather state may include any one of a state in which an external temperature is out of a predetermined temperature or higher than the predetermined temperature, a state of being forecasted that precipitation that is greater than or equal to predetermined precipitation has occurred or will occur, a state in which a wind speed is higher than or equal to a predetermined speed, or a combination thereof.

The communication unit 430 is connected to the processor 410 to directly obtain information or transmit and/or receive information from an external server or an external device. For example, the communication unit 430 receives situation information of the vehicle, an origin or a destination of the vehicle, or external environment information of the vehicle from an external server or an external device.

The memory 450 may be various types of volatile or non-volatile storage media. In the instant case, the memory 450 may store at least one of a battery state of a vehicle, a travel situation information of the vehicle, state information of a driver, information on an origin or a destination, external environment information of the vehicle, or a combination thereof.

In various exemplary embodiments of the present disclosure, the control device may be implemented in a form of hardware or software, or may be implemented in a combination of hardware and software.

As described above, the configuration and method of the above-described embodiments are not limitedly applied to the autonomous driving mode control method and apparatus based on the situation according to an exemplary embodiment of the present disclosure, but all or some of the exemplary embodiments of the present disclosure may be configured in a selective combination thereof so that the exemplary embodiments may be variously modified.

According to the above-described embodiments of the present disclosure, it is possible to minimize the power consumption of the vehicle by optimizing the autonomous driving level for each road section in the driving route of the autonomous driving vehicle and recommending the optimized level to the driver.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An autonomous driving mode control method including:
setting, by a controller, a driving route based on an origin and a destination of a vehicle;
comparing, by the controller, an expected state of charge (SOC) value of a battery at the destination with a predetermined SOC; and
controlling, by the controller, travel of the vehicle by determining whether to activate a high-level driving mode in consideration of at least one of whether a dangerous situation occurs, a result of the comparing, or a safety level of the driving route.

2. The autonomous driving mode control method of claim 1, wherein the controlling of the travel of the vehicle further includes:
warning the dangerous situation to a driver in response that the dangerous situation occurs while the vehicle travels and transmitting an inquiry about whether to activate the high-level driving mode to the driver; and
controlling the travel of the vehicle by activating the high-level driving mode upon receiving acceptance of the activation for the high-level driving mode from the driver.

3. The autonomous driving mode control method of claim 1, further including:
controlling the travel of the vehicle by activating the high-level driving mode in response that the expected SOC value of the battery at the destination is equal to or greater than the predetermined SOC; and
controlling the travel of the vehicle by downgrading an autonomous driving level in response that the safety level of the driving route is greater than a predetermined safety level.

4. The autonomous driving mode control method of claim 1, wherein the safety level of the driving route is determined based on a number of vehicles passing a forward road in the driving route, a curvature of the forward road in the driving route, and a visibility range.

5. The autonomous driving mode control method of claim 1, further including:
adding a charging station in the driving route as a stopover.

6. The autonomous driving mode control method of claim 1, wherein the dangerous situation includes a dangerous state of a driver or a bad weather state.

7. The autonomous driving mode control method of claim 6, wherein the dangerous state of the driver includes any one of a drowsy driving state of the driver or a distracted state of the driver.

8. The autonomous driving mode control method of claim 6, wherein the drowsy driving state of the driver is a state in which the driver's eyelids are closed above a predetermined range.

9. The autonomous driving mode control method of claim 7, wherein the distracted state of the driver is a state in which the driver's head rotates at a predetermined angle or more than the predetermined angle from a front of the driver.

10. The autonomous driving mode control method of claim 6, wherein the bad weather state includes any one of a state in which an external temperature is out of a predetermined temperature or higher than the predetermined temperature, a state of being forecasted that precipitation which is greater than or equal to predetermined precipitation has occurred or will occur, a state in which a wind speed is higher than or equal to a predetermined speed, or a combination thereof.

11. An autonomous driving mode control apparatus comprising:
a sensor unit configured to obtain a battery state of a vehicle, driving situation information of the vehicle, or state information of a driver;
a communication unit configured to receive situation information of the vehicle, an origin or a destination of the vehicle, or external environment information of the vehicle from an external server or an external device; and
a controller communicatively connected to the sensor unit and the communication unit and configured to control travel of the vehicle by setting a driving route based on the origin and the destination, comparing an expected state of charge (SOC) value of a battery at the destination with a predetermined SOC value, and determining whether to activate a high-level driving mode in consideration of at least one of whether a dangerous situation occurs, a result of the comparing, or a safety level of the driving route.

12. The autonomous driving mode control apparatus of claim 11, wherein the controller is further configured to:
warn the dangerous situation to a driver in response that the dangerous situation occurs while the vehicle travels and transmit an inquiry about whether to activate the high-level driving mode, to the driver; and
control the travel of the vehicle by activating the high-level driving mode upon receiving acceptance of the activation for the high-level driving mode from the driver.

13. The autonomous driving mode control apparatus of claim 11, wherein the controller is further configured to:
control the travel of the vehicle by activating the high-level driving mode in response that the expected SOC value of the battery at the destination is equal to or greater than the predetermined SOC; and
control the travel of the vehicle by downgrading an autonomous driving level in response that the safety level of the driving route is greater than a predetermined safety level.

14. The autonomous driving mode control apparatus of claim 13, wherein the safety level of the driving route is determined based on a number of vehicles passing a forward road in the driving route, a curvature of the forward road in the driving route, and a visibility range.

15. The autonomous driving mode control apparatus of claim 11, wherein the controller is further configured to add a charging station in the driving route as a stopover.

16. The autonomous driving mode control apparatus of claim 11, wherein the dangerous situation includes a dangerous state of a driver or a bad weather state.

17. The autonomous driving mode control apparatus of claim 16, wherein the dangerous state of the driver includes any one of a drowsy driving state of the driver or a distracted state of the driver.

18. The autonomous driving mode control apparatus of claim 16, wherein the drowsy driving state of the driver is a state in which the driver's eyelids are closed above a predetermined range.

19. The autonomous driving mode control apparatus of claim 17, wherein the distracted state of the driver is a state in which the driver's head rotates at a predetermined angle or more than the predetermined angle from a front of the driver.

20. The autonomous driving mode control apparatus of claim 16, wherein the bad weather state includes any one of a state in which an external temperature is out of a predetermined temperature or higher than the predetermined temperature, a state of being forecasted that precipitation which is greater than or equal to predetermined precipitation has occurred or will occur, a state in which a wind speed is higher than or equal to a predetermined speed, or a combination thereof.
